(19) United States
(12) Patent Application Publication
(10) Pub. No.: US 2009/0216819 A1
(43) Pub. Date: Aug. 27, 2009

(54) Stairway dimensions comparative calculator

(76) Inventor: Eric Gobeil, Quebec City (CA)

Correspondence Address: ERIC GOBEIL;c/o PAUL BIRON, P.O. BOX 0732, JACKMAN, ME, 04945-0732, US

(21) Appl. No.: 12/322,793

(22) Filed: Feb. 6, 2009

Related U.S. Application Data
(60) Provisional application No. 61/026,838, filed on Feb. 7, 2008.

(51) Int. Cl. G06F 3/02

(52) U.S. Cl. 708/134

(57) ABSTRACT

An electronic spreadsheet or hand user calculator consists of an array of cells some containing formulas some into which a user enters stair dimension values such as total rise and run. After the user has entered such values the formulas proceed to other stair dimension calculations; then results are displayed on the spreadsheet. The system provides a facility not available on conventional electronic stair calculator spreadsheets: the first column provides results corresponding to initial values entered by the user and a second column, next to the first, allows to compare stair dimensions when the user plugs a different number of steps. For example an entered total rise of 111″ and run of 10.5″ will give, in the first column 14 steps each having a rise of 7.4″. Using a second column to compare stair dimension results for 15 steps shows a rise of 6.94″.

### BACKGROUND OF THE INVENTION

The invention relates to the field of calculation devices providing results for stair case dimensions for use in assembly thereof.

### PRIOR ART

A study of the prior art has revealed the following:

U.S. Pat. No. 4,488,250 Lipsey converting from metric to standard;

U.S. Pat. No. 4,744,044 Stover provides an outlet; does not compare variables;

U.S. Pat. No. 6,983,245 Jimenez compares curves;

U.S. Pat. No. 5,272,653 Meta shows ranges from metric to standard;

U.S. Pat. No. 4,961,362 Gunn provides a rotatable section;

U.S. Pat. No. 4,220,075 Bromberg shows a sheet ruler with two leaves;

U.S. Pat. No. 4,349,346 Bromberg shows data without a comparison;

U.S. Pat. No. 6,742,162 Bennett uses a cluster of numbers located next to lines of sets of data but it does not show a comparison of limited columns such as may be useful in providing a set of related data within a rectangular triangle such as a staircase.

### OBJECTS OF THE INVENTION

To make a staircase, stair builders need to make many calculations; the goal of this invention is to provide them with the same results with fewer calculations.

For each needed output, builders only have to plug their own staircase inputs or dimensions into a calculating device and obtain accurate results.

A further object is to put formulas side by side, in parallel columns, so the user can see comparative data needed to choose the proper combination with which to build his staircase.

In addition, to make his final decision on staircase dimensions, the builder will have to compare how a different number of risers will change other staircase dimensions, such as step height and total run. This invention not only makes the usual calculations for the staircase, but also provides the user with comparison results when changing the number of risers. The stairway calculator method is to be applicable to and be embodied with: a pocket calculator, a desk calculator, as a function of a web site, Excel® or other spreadsheet or calculating program, or other formats capable of showing comparison results for the described calculations.

Other objects and advantages of this invention shall appear from a careful reading of the detailed description attached and with reference to the drawings.

### BRIEF DESCRIPTION OF DRAWING FIGURES

FIG. 1 is a schematic of a calculator.

FIG. 2 is a cut view of a stairway.

FIG. 3 is a photograph of an installation handbill.

### DETAILED DESCRIPTION OF A PREFERRED EMBODIMENT

In the following description and in the accompanying drawings, the numeral numbers refer to identical parts in the various Figures.

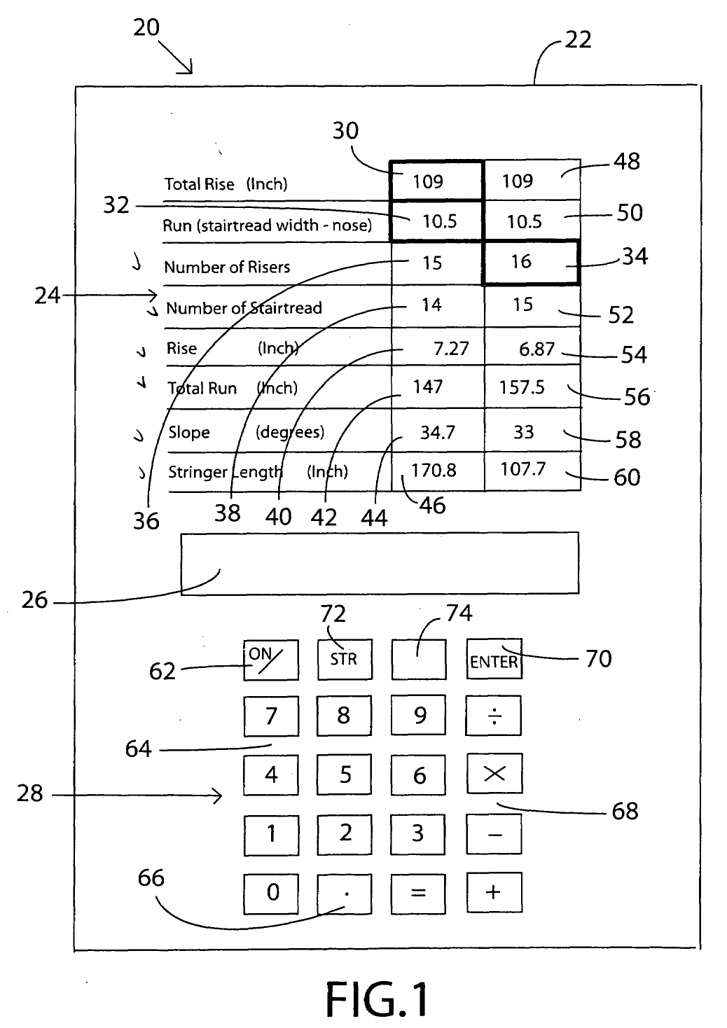

In FIG. 1 one sees a portable electronic calculator 20 with a housing 22 comprising a number table 24, an opened display 26 and a set of keys 28. Also shown is a calculating table 64, a power source 62, a decimal point 66 and basic operations 68. To access the above table one must press a key STR (stair tread) 72 located neat a possible other key 74. In the first column of the number table a first case is to show total rise display 30, for instance in the English system of measuring and depress the enter key 70 to confirm the number. The first column, second position, shows a run (stair tread minus nose) 32 followed by inserting the enter key to confirm the number. The electronic calculator will compute the data in the following positions in the first column. And the second column becomes a repeat of the first column. Comparison results appear when hitting the case comparitive risers 34 in the second column. In the first column there appears number of risers 36, number of stair treads 38, rise in inches 40, total run 42, slope 44, stringer length 46 while the proper number appears in the second column in the following boxes total rise repeat 48, run repeat 50, compared stairtread 52, compared rise 54, compared total run 56, compared slope 58 and compared stringer length 60.

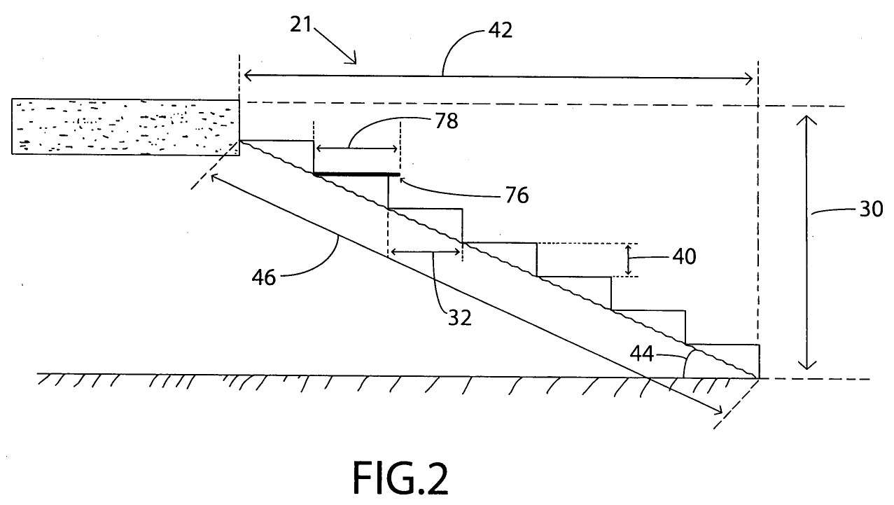

In FIG. 2 one sees a stairway 21 with a measurement of the total run 42, the total rise display 30, the run value display 32, the rise in inches 40, the slope 44, the stringer length 46, the nose 76 and the run 32, the stair tread width 78 comprises the nose and the run.

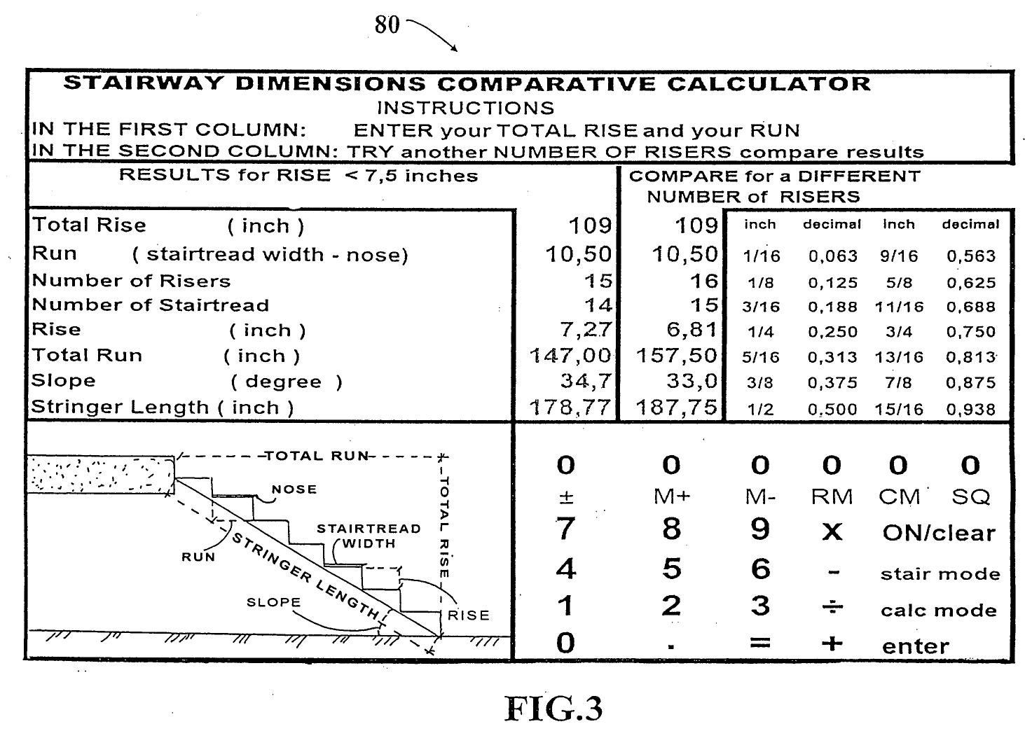

In FIG. 3 one sees a typical installation handbill 80.

### SUMMARY OF THE INVENTION

An electronic spreadsheet or hand user calculator consists of an array of cells some containing formulas into which a user enters stair dimension values such as total rise and run. After the user has entered such values the formulas proceed to other stair dimension calculations wherein results are displayed on the spreadsheet. The system provides a facility not available on conventional electronic stair calculator spreadsheets: the first column provides results corresponding to initial values entered by the user and a second column, next to the first, allows to compare stair dimensions when the user tries a different number of steps than what was calculated by formulas in the first column. For example an entered total rise of 111″ and run of 10.5″ will give, in the first column 14 steps each having a rise of 7.4″, the designer will use the second column to compare stair dimension results for 15 steps and obtain a rise of 6.94″. Other dimensions provided in the two columns are such as total run, slope or whatever will help designer choose the number of steps and other stair dimensions appropriate for his project.

### Calculator Embodiment

A portable electronic calculator 20 for staircase calculations, the calculator having a housing 22 containing a display 26, numerical and functional keys 28 and means operatively connected to the numerical and functional keys for performing a plurality of predetermined computations based upon which keys are pressed, the performing means being operatively connected to the display for displaying the results of the computations, the calculator comprising:

field keys interconnected with the performing means, the field keys comprising each of the following input keys:

a set of keys 28 comprising a calculating table 64 with basic operations 68 and a stair tread key (STR) 72, the STR key 72 adapted to trigger a number table 24 comprising three columns, a first column comprising a list of variables and two columns comprising windows to display values of the variables, a first variable being quantified by a total rise input key 30, a value thereof being displayed in the first column by hitting an enter key 70, means for energizing a second window in the first column and displaying a second value, a second variable being quantified by a run key 32, wherein the run is comprising a stair tread width less a nose size, a value thereof being displayed in the second window of the first column by hitting the enter key, means for calculating and displaying remaining variables in the first column, means for repeating, calculating and displaying values of the first, second and remaining variables in the second column, means for displaying a third variable in the second column, a comparative key 34 permitting the plugging of an alternate third variable, the calculator displaying a new array of variables permitting to compare stair dimensions when changing a variable. The third variable is a number of risers. The first variable is a total rise in inches. The second variable is a run (stairtread width less nose). The remaining variables comprise a number of stairtreads 38, a slope 44 resulting in a more or less steep staircase, a stringer length 46. Other remaining variables comprise a rise 40 and a total run 42. The columns may be horizontal rows.

A method of calculating staircase dimensions with a pocket calculator comprising the following steps: select a set of keys 28 comprising a calculating table 64 with basic operations 68 and a stair tread key (STR) 72, the STR key adapted to trigger a number table 24 comprising three columns, a first alphanumerical column comprising a list of variables (eight shown) and two numerical columns comprising windows to display values of the variables, a first variable being quantified by a total rise input key 30, a value thereof being displayed in the first numerical column by hitting numbers in the calculating table 64 followed by the enter key 70, energizing a second window and displaying a second value, selecting a second variable being quantified by a run key 32, thereby calculating and displaying remaining variables in the first numerical column, repeating, calculating and displaying values of the first, second and remaining variables in the second numerical column, by entering the third variable in the second numerical column, by hitting a comparative key 34 permitting the plugging of an alternate third variable, the calculator displaying in the second numerical column a new array of variables permitting to compare stair dimensions when changing a variable.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims.

### PARTS LIST

20—Electronic calculator
21—Stairway
22—Housing
24—Number table
26—Display
28—Set of keys
30—Total rise display
32—Run (Stair tread minus nose)
34—Comparative risers
36—Number of risers
38—Number of stair treads
40—Rise in inches
42—Total run (inches)
44—Slope (degrees)
46—Stringer length (in.)
48—Total rise repeat
50—Run repeat
52—Compared stairtread
54—Compared rise
56—Compared total run
58—Compared slope
60—Compared stringer length
62—Power source
64—Calculating table
66—Decimal point
68—Basic operations
70—Enter key
72—STR key (stair tread)
74—Other key
76—Nose
78—Stair tread width
80—Handbill

I claim:

1. An electronic calculator (20) for slanted object calculations, said calculator having a housing (22) containing a display (26), numerical and functional keys (28) and means operatively connected to said numerical and functional keys for performing a plurality of predetermined computations based upon which keys are pressed, said performing means being operatively connected to said display for displaying the results of said computations, said calculator comprising:
field keys interconnected with said performing means, said field keys comprising each of the following input keys:
a set of keys (28) comprising a calculating table (64) with basic operations (68) and a stair tread key (STR) (72), said STR key (72) adapted to trigger a number table (24) comprising three columns, a first alphanumerical column comprising a list of variables and two numerical columns comprising windows to display values of said variables, a first variable being quantified by an input key (30), a value thereof being displayed in a first said numerical column by hitting an enter key (70),
means for energizing a second window in said first numerical column and displaying a second value, for a second variable, a value thereof being displayed in said second window of said first numerical column by hitting said enter key,
means for calculating and displaying remaining variables in said first numerical column,
means for repeating, calculating and displaying values of said first, second and remaining variables in said second column,
means for displaying a third variable in said second column, a comparative key (34) permitting the plugging of an alternate said third variable, said calculator displaying a new array of variables permitting to compare a slanted object dimensions when changing a variable.

2. The calculator of claim 1 wherein said input key is a total rise key (30) of a first variable of a staircase; a second variable being quantified by a run (32), wherein said run is comprising a stair tread width less a nose size, said slanted object being a staircase.

3. The calculator of claim 2 wherein said third variable is a number of risers (34).

4. The calculator of claim 2 wherein said third variable is a number of runs (52), or number of steps.

5. The calculator of claim 2 wherein said first variable is a total rise in inches.

6. The calculator of claim 2 wherein said second variable is a run (stairtread width less nose).

7. The calculator of claim 2 wherein said remaining variables comprise a number of risers, a slope resulting in a more or less steep stair case, a stringer length (46).

8. The calculator of claim 7 wherein said remaining variables comprise a number of stairtread (38), a rise (40), a total run (42).

9. A method of calculating staircase dimensions with calculator means comprising a pocket calculator, a spreadsheet, a website application, a format or support, said method comprising the following steps:
select a set of keys (28) comprising a calculating table (64) with basic operations (68) and a stair tread key (STR) (72), said STR key (72) adapted to trigger a number table (24) comprising three columns, a first column comprising a list of variables and two columns comprising windows to display values of said variables, a first variable being quantified by a total rise input key (30), a value thereof being displayed in said first column by hitting an enter key (70),
energize a second window in said first column and display a second value,
select a second variable being quantified by a run key (32), wherein said run is comprising a stair tread width less a nose size, a value thereof being displayed in said second window of said first column by hitting said enter key,
thereby calculating and displaying remaining variables in said first column,
select means for repeating, calculating and displaying values of said first, second and remaining variables in said second column,
display a third variable in said second column,
hit a comparative key (34) permitting the plugging of an alternate said third variable, said calculator displaying a new array of variables permitting to compare stair dimensions when changing a variable.
